(19) United States
(12) Patent Application Publication
(10) Pub. No.: US 2005/0069098 A1
(43) Pub. Date: Mar. 31, 2005

(54) Unified user interface to a communication network

(76) Inventors: Matti Kalervo, Helsinki (FI); Reijo Juvonen, Espoo (FI); Mark Suoknuuti, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/499,006

(22) PCT Filed: Dec. 21, 2001
(86) PCT No.: PCT/EP01/15249

(51) Int. Cl. H04M 11/00; H04Q 7/20

(52) U.S. Cl. 379/88.13; 379/88.12; 379/88.14; 455/466

(57) ABSTRACT

The invention relates to a method and system for providing a unified user interface to a communication network, comprising means for generating the user interface based on user mode (2), and means for converting the user mode to a presentation mode (3) using a list (4) of attributes for presentation. The user interface (1) is generated additionally taking account of the connectivity level. Selection means for selecting the user mode by a user, and detection means for automatically detecting available connectivity levels at the current environment may be provided.

### FIELD AND BACKGROUND OF THE INVENTION

The invention relates to communication network and communication system, and in particular to a unified user interface to a communication network.

In the current communication networks the user navigates and gets connected with other users or services, using technology oriented addressing schemes, e.g. phone and fax numbers, email addresses, Web addresses (URL's), news addresses. When many users are connected and reachable through many of these addresses, managing and remembering these addressing schemes and their interrelations gets very complicated and difficult for the user. E.g. directories, (electronic) phone books and search engines partially try to help user in managing the addresses.

Further, known prior art solutions are limited in their scope and in their ability to hide the technical details of the communication networks. In addition they do not provide tools to manage different authenticable or anonymous roles of the users nor their physical or virtual presence in these roles.

### SUMMARY OF THE INVENTION

The present invention provides a method and system as defined in the independent claims or any one of the dependent claims.

In accordance with one aspect of the invention, a method, and system are disclosed which provide a unified user interface to a communication network, allowing unified messaging.

The invention presents a method and system to navigate in an communication network and present the network environment to the user in a natural and human way. The communication network environment can be presented in an easily understandable, unified way.

This invention further provides a system and method allowing user(s) to be identified differently in her/his different roles.

In accordance with an aspect of the invention, Internet-based graphical multi-user environment technology similar to graphical versions of MUD, MOO (MUD=Multi User Domain/Dungeon/Dimension; MOO=MUD, Object Oriented) are preferably used to create adaptable virtual user interfaces—presentation modes for devices/terminals that have unified messaging functionality.

Adaptable user-interfaces are used to visualize the virtual place where a user meets other users, communicates, supplements documents, and/or uses user services.

Furthermore, created virtual presentation modes are preferably related to available connectivity and activity level of the user, and user(s) may also see the presentation modes available for other users or elements, clients with which she/he is in communication.

The invention provides a solution for problems concerning addresses and protocols by which to contact another person or service. Further, a user can have many roles in which he is being contacted using the same environment.

Communication ways/documents/people can be presented as objects that cover the underlying technology.

### BRIEF DESCRIPTION OF THE DRAWINGS

FIG. 1 illustrates a basic embodiment of a Unified User Interface Structure in accordance with an embodiment of the invention,

FIG. 2 shows a basic structure of a communication system and method in accordance with an embodiment of the invention.

FIG. 3 illustrates another basic Unified User Interface Structure in accordance with a further embodiment of the invention.

### DETAILED DESCRIPTION OF PREFERRED EMBODIMENTS OF THE INVENTION

The invention provides a method and system providing a unified user interface to a communication network. The unified user interface is access-independent and provides access into API—interface in the core of network. The unified user interface is virtual by nature and allows non-technical addressing

The term “unified messaging” or rather “unified communications” as used here has the meaning of integration of several different communications media, such that users will be able to communicate e.g. using realtime peer-to-peer connections, multimedia messaging and browsing (information retrieval) from a single interface, whether it be a wireline phone, wireless phone; PC; or TV or Internet-enabled TV.

Basically, the invention introduces a new method to navigate in a communication network and to present the network environment to the user in an easily understandable, unified way, hiding the technical details. It also provides way for the user to be differently identified in his/her different roles. The invention proposes to use Internet-based graphical multi-user environment technology to create adaptable virtual user interfaces/ presentation modes for devices/terminals that have unified messaging functionality. The user interfaces are used to visualize the virtual place where you meet other users, communicate, supplement documents and/or use user services. The presentation modes are also related to connectivity and activity level of the user e.g. Wide Area Network coverage (e.g. GSM/GPRS coverage)/Office/Home connectivity, Communication and commitment/Reading and browsing/Passive.

The invention can be implemented in a variety of ways.

As an example, technologies of multi-user virtual reality games available in Internet provide tools to create different presentation modes for the invention.

Presentation modes related to end-users activity status may be characterized e.g. in four levels
1. Communication and commitment,
2. Passive,
3. Reading and browsing,
4. Observing and controlling.

Presentation modes related to connectivity level of unified messaging may have e.g. three levels:
1. Coverage of Wide Area Networks, e.g. GSM/GPRS coverage
2. Office connectivity
3. Home connectivity with IP connectivity, e.g. fixed IP access in addition to wide area network (e.g. GSM/GPRS).

In an embodiment of the invention the users access the network with API-interface (API=Application Program(ming) Interface) in core. The user and the network separately or together affect the virtual and dynamic user interface and generate different “windows”, presentation modes, within the services and allow also other users to see this presentation mode or part of it. The presentation mode can include the location of the user, map, phonebook, document, activity condition, newsgroup, calendar, TV program etc. Technically, virtual game technologies like MUD and MOO may be combined with unified messaging. So, all the services (PSTN, GSM, fax, e-mail, www, tv, map etc.) may be provided on top of IP-protocol to build a so-called Rich Call. The terminal is independent from the physical interface of the network and the user can use different terminals to access all the services.

The invention is preferably implemented in the graphical user-interface of mobile internet appliances (e.g. mobile phones, PDAs), and as a protocol between the mobile internet appliances and servers in the network.

The system using this invention may use the existing networks and protocols, but their details can/will be hidden from the user by the user-interface. As the immediate impact of the invention is limited to the mobile internet appliance, its graphical user-interface and to the supporting servers in the network, smooth and gradual introduction in the market is possible.

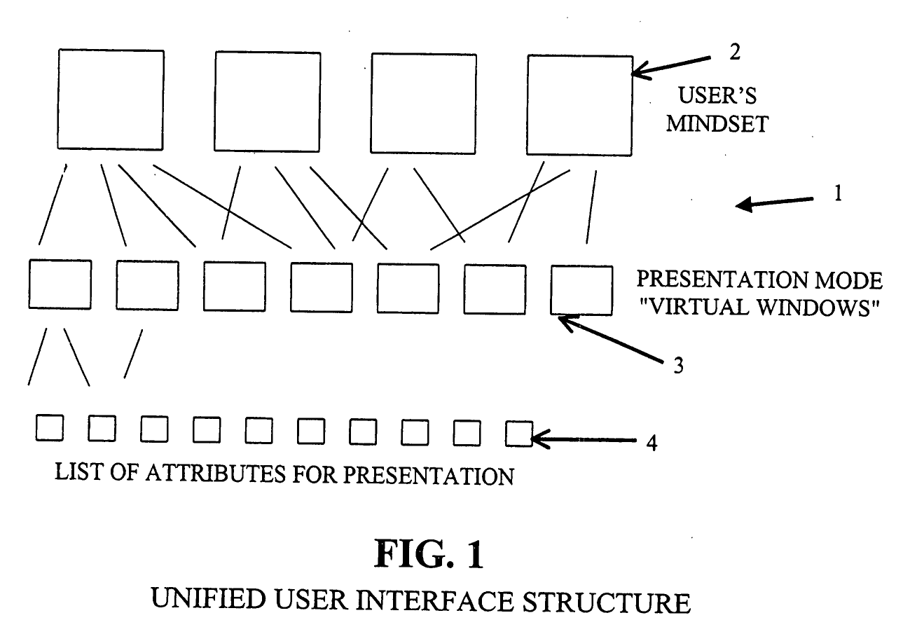

FIG. 1 shows a basic embodiment of the structure of a Unified User Interface 1 in accordance with the invention.

A User's Mindset 2 is converted to a Presentation Mode “Virtual Windows” 3, using a List of Attributes for Presentation 4.

The proposed UI (User Interface) 1 concept is based on three components U, P, C and their automated interaction:
[User Mindset U]×[Presentation Mode P]×[Connectivity Level C]=U×P×C.

Based on the User Mindset U (which is selectable by the user) and available Connectivity Levels C (automatically detected at the current environment), the RULES for selecting the active Presentation Modes (from the set of available Presentation Modes) can be defined by the user or a service provider.

The expression “User(s) Mindset” has the meaning of “User(s) mode” or “(User's) predisposition”. Users modes may be selected according to the users predisposition or user's activity status, which may be characterized e.g. in four levels: Communication and commitment; Passive; Reading and browsing;—Observing and controlling.

A user can create new modes (mindsets), e.g. using a tool to create modes, or a user can buy or download new modes e.g. from operators/service providers/third party.

User Modes 2, Presentation Modes 3 and Connectivity Levels are definable and can be defined and modified through: a) a toolset which is part of this user interface, and/or b) by downloading them from a service provider or from another user.

A user can show selectable parts of her/his U×P×C status to other users, to a group of users and to service providers (defined as part of the U×P×C definition).

As regards the Connectivity Level, the selection of connectivity level in Mindset modes may be performed automatically or manually. The connectivity level may have e.g. three levels: GSM/GPRS coverage; Office connectivity; Home connectivity with fixed IP access in addition to GSM/GPRS.

The selection of available devices and additional features (Mindset Parameters) in Mindset Modes may be performed automatically or manually e.g. using TV, Printer, or Privacy.

Regarding Presentation Modes, the users can create new presentation modes e.g. by means of a tool to create presentation modes. Further, the user can buy new presentation modes provided e.g. by operators/service providers or third parties.

The attributes and services in Presentation Modes can be selected automatically or created by the user.

Presentation Mode Attributes can include e.g.
Id: Logo, Picture, Sound, Text;
Presence: Mindset, Active Presentation Modes;
Address: Routing, Tel number , web/URL; email;
Call: SIP;
UI: Mud/Moo-text; Graphical “protocol”;
Available networks: GSM, LAN . . . ;
Available devices: service discovery;
Privacy,
Security.

Presentation Modes are virtual by nature. The presentation Modes provide non-technical addressing. The presentation modes are used to visualize the virtual place where the user(s) meet other users, communicate, supplement documents, and/or use user services. The presentation modes are related to available connectivity and activity level of the user and user may also see the presentation modes available of other users or elements, clients with which she/he is in communication.

Internet-based graphical multi-user environment technology e.g. graphical versions of MUD, MOO and virtual reality games are preferably used to create adaptable virtual user-interfaces—presentation modes.

The invention is able to hide the technical details of the communication networks. In addition it provides tools for managing different authenticable or anonymous roles of the users and their physical or virtual presence in these roles.

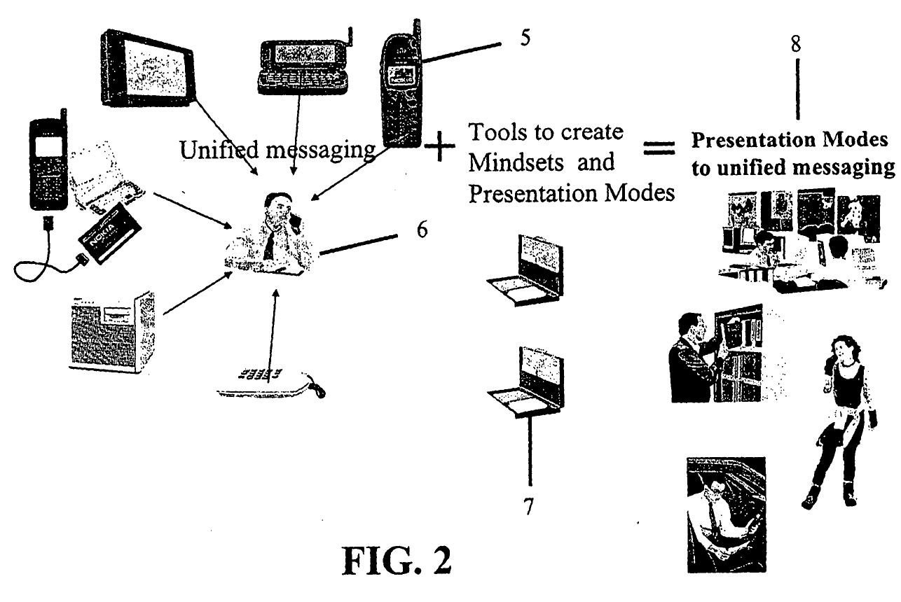

FIG. 2 shows a basic structure of a communication system and method in accordance with an embodiment of the invention. The arrows of FIG. 2 represent Unified messaging between different terminals 5 and a user 6. Portable or stationary computers 7 or other devices may provide tools to create Mindsets and Presentation Modes, resulting in Presentation Modes 8 to unified messaging.

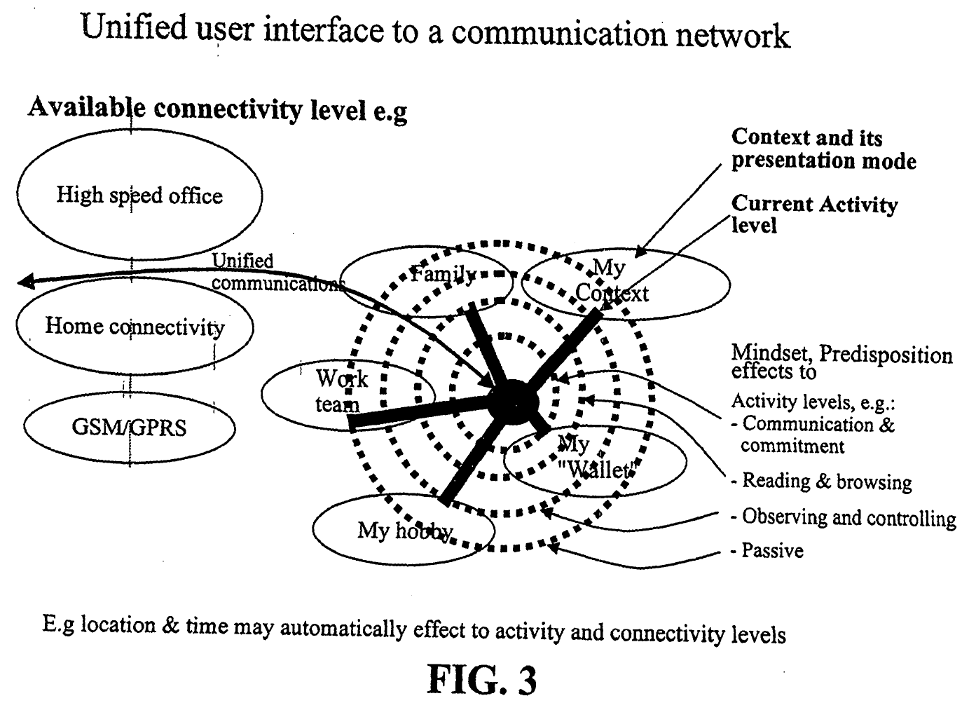

FIG. 3 illustrates another basic Unified User Interface Structure to a communication network in accordance with a further embodiment of the invention. As shown on the left hand side of FIG. 3, available connectivity level are e.g. High speed office; Home connectivity; GSM/GPRS.

Context and its presentation mode are represented by several concentric circles of different radii: My “Wallet”; “Family”; “My hobby”; “Work team”; “My Context”. The activity levels are represented by thick radial lines, e.g. as symbolized by the arrow “Current Activity level”.

Mindset, Predisposition effects to Activity levels, e.g. are:
Communication & commitment,
Reading & browsing,
Observing and controlling,
Passive.

E.g. location & time may automatically effect to activity and connectivity levels.

Although the invention has been described above with reference to specific embodiments, the scope of the invention also covers any alterations, additions, modifications, and omissions of the disclosed features.

1-13. (Cancelled).

14. Method for providing a unified user interface to a communication network,
wherein the user interface is generated based on components User Mode, Presentation Mode, and Connectivity Level and their automated interaction,
wherein User Mode is selectable by the user, available Connectivity Levels are automatically detected at the current environment, and the Presentation Mode takes into account the location of the user,
the User Mode being converted to a Presentation Mode using a list of attributes for presentation, the attributes including information related to identity, presence, address, routing, call protocols, available networks, available devices, privacy and/or security.

15. Method according to claim 14, wherein the user interface is created dependent on an activity level of the user.

16. Method according to claim 15, wherein the activity level of the user includes at least one of the levels: Communication and commitment; Passive; Reading and browsing; Observing and controlling.

17. Method according to claim 14, wherein the user interface is a graphical user interface of a mobile internet appliance.

18. Method according to claim 14, wherein location and time are taken into account for Activity Level and Connectivity Level.

19. Method according to claim 14, wherein rules for selecting active presentation modes from a set of available presentation modes are defined by a user or a service provider.

20. Method according to claim 14, wherein the Presentation Modes are used to visualize the virtual place where the user(s) meet other users, communicate, supplement documents, and/or user services.

21. Method according to claim 14, wherein tools are provided for creating the User Modes and/or Presentation Mode, or for changing the properties of these modes.

22. System for providing a unified user interface to a communication network, comprising
means for generating the user interface based on components User Mode, Presentation Mode, and Connectivity Level and their automated interaction, wherein User Mode is selectable by the user, available Connectivity Levels are automatically detected at the current environment, and the Presentation Mode takes into account the location of the user, and
means for converting the User Mode to a Presentation Mode using a list of attributes for presentation, the attributes including information related to identity, presence, address, routing, call protocols, available networks, available devices, privacy and/or security.

23. System according to claim 22, comprising selection means for selecting the user mode by a user, and detection means for automatically detecting available connectivity levels at the current environment.

24. System according to claim 22, comprising means for defining rules for selecting active presentation modes from a set of available presentation modes by a user or by a service provider.

25. System according to claim 22, comprising means for visualizing virtual place where user(s) meet other users, communicate, supplement documents, and/or use user services.

26. System according to claim 22, comprising tools for creating the user's modes and/or presentation mode, or for changing the properties of these modes.
